(19) United States
(12) Patent Application Publication
(10) Pub. No.: US 2018/0141780 A1
(43) Pub. Date: May 24, 2018

(54) ELEVATOR CAR INCLUDING CAR OPERATIONAL PANEL GRAPHICAL INTERFACE

(71) Applicant: OTIS ELEVATOR COMPANY, Farmington, CT (US)

(72) Inventors: Dominguez FRANCK, Loiret (FR); Frederic BEAUCHAUD, Coullons (FR)

(21) Appl. No.: 15/570,121

(22) PCT Filed: Apr. 28, 2015
(86) PCT No.: PCT/IB2015/000841

§ 371 Date: Oct. 27, 2017

(51) Int. Cl. B66B 5/00; G06F 3/16; B66B 3/00

(52) U.S. Cl. CPC B66B 5/0025; B66B 5/0087; B66B 3/002; G06F 3/167

(57) ABSTRACT

An electronic car operation panel (COP) module including a display screen and an input sensor configured to detect a service query includes an electronic memory unit that stores service/maintenance information. An electronic COP controller unit includes a microprocessor configured to execute computer-readable instructions stored in the electronic memory unit to retrieve the service/maintenance information in response to the service query. The electronic COP controller unit is further configured to output an electronic display signal indicative of the service/maintenance information. The COP module is further configured to display the service/maintenance information in response to receiving the electronic display signal.

### TECHNICAL FIELD

The present disclosure generally relates to elevator system, and in particular, to elevator car maintenance systems.

### BACKGROUND

Elevator systems typically require maintenance and service throughout the operational lifetime of the system. Maintenance and service work is typically performed by one or more elevator service technicians. However, a variety of different elevator systems exists, which are designed and operate differently from one another. Therefore, a service technician may be required to understand how each elevator system is designed and operates. Due to the large variety of elevator system designs, a service technician is required to analyze a large amount of printed material such as, for example, user manuals and mechanical schematics, in order to gain insight on the technical operation of a particular elevator system and diagnose any problems that exist. Moreover, each service and/or maintenance job typically requires creation of a subsequent service report indicating the type of service and/or maintenance that was performed with each job. These service reports are usually reviewed by service technicians prior to performing a service or maintenance work. Therefore, additional paper work is continuously added over the operating lifetime of the elevator system.

### SUMMARY

According to embodiment, an elevator car driven by an elevator system, includes an electronic car operation panel (COP) module including a display screen and an input sensor configured to detect a service query, an electronic memory unit that stores service/maintenance information, and an electronic COP controller unit including a microprocessor configured to execute computer-readable instructions stored in the electronic memory unit to retrieve the service/maintenance information in response to the service query and output an electronic display signal indicative of the service/maintenance information. The COP module is configured to display the service/maintenance information in response to receiving the electronic display signal.

In addition to one or more of the features described above or below, or as an alternative, further embodiments include:

a feature, where the COP module is installed inside the elevator car;

a feature, where the electronic COP controller unit is configured to determine at least one diagnostic fault of at least one of the elevator car and the elevator system, and output a diagnostic signal indicative of the at least one diagnostic fault;

a feature, where the COP module is configured to display an image corresponding to the at least one diagnostic fault;

a feature, where the COP module is configured to overlay at least one diagnostic indicator on the image identifying a location of the diagnostic fault;

a feature, where the COP module includes an audio system configured to receive a vocal request;

a feature, where the electronic COP controller unit is configured to retrieve the service/maintenance information in response to the vocal request and output the electronic display signal indicative of the service/maintenance information;

a feature, where the audio system is configured to output vocal information corresponding to the retrieved service/maintenance information;

a feature, where the COP module is configured to wireless transmit the service/maintenance information to at least one electronic mobile device;

a feature, where the service/maintenance information includes at least one of electrical schematics, mechanical schematics, elevator system blueprints, part lists and images, video files, maintenance/service history and checklist, and step-by-step instructions for diagnosing and repairing a diagnosis fault and step-by-step instructions for maintenance; and

a feature, where the display screen is configured to display a request to order at least one replacement part, and automatically order the at least one replacement part in response to receiving a confirmation via the COP module to order the at least one replacement part.

According to another embodiment, a method of performing service/maintenance on an elevator system comprises storing service/maintenance information corresponding to at least one of the elevator system and an elevator car included in the elevator system, inputting a service query to an electronic car operation panel (COP) module installed on the elevator car, retrieving the service/maintenance information in response to the service query, and displaying the service/maintenance information on a display screen of the COP module in response to retrieving the service/maintenance information.

In addition to one or more of the features described above or below, or as an alternative, further embodiments include:

a feature where the COP module is installed inside the elevator car;

a feature of receiving a request to diagnose at least one of the elevator system and the elevator car via the COP module, determining an existence of at least one diagnostic fault in response to the diagnosis, and displaying an image via the COP module that identifies a location of the at least one diagnostic fault; and

a feature where the service/maintenance information includes at least one of electrical schematics, mechanical schematics, elevator system blueprints, part lists and images, video files, maintenance/service history, and step-by-step instructions for diagnosing and repairing a diagnosis fault.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 illustrates an elevator system including an elevator car having a car operating panel (COP) module configured to perform maintenance, service, and/or diagnostic operations according to a non-limiting embodiment;

FIG. 2 illustrates a COP module including a graphical user interface configured to perform maintenance, service, and/or diagnostic operations according to a non-limiting embodiment; and

FIG. 3 is a flow diagram illustrating a method of performing service and/or maintenance on an elevator system according to a non-limiting embodiment.

### DETAILED DESCRIPTION OF THE INVENTION

Various embodiments of the disclosure provide an elevator system including an elevator car having a car operating panel (COP) module configured to perform maintenance, service, and/or diagnostic operations. Conventional COPs are primarily used as a means for allowing passengers to input an elevator car request and/or a desired floor at which to deliver the elevator car. At least one embodiment of the present inventive teachings, however, provides an elevator car including a COP module having a graphical user interface configured to display service/maintenance information to an elevator service technician from within the elevator car.

The COP module includes an electronic microprocessor having electronic memory that executes computer readable instructions stored on an electronic memory unit to display various types of service/maintenance information to the service technician. It should be appreciated that the memory device can be installed internally of the COP module or externally from the COP module. The service/maintenance information may include, but is not limited to, electrical and/or mechanical schematics, blueprints of the elevator system and/or car, part lists, maintenance and/or service history, and step-by-step instructions for diagnosing and/or repairing the elevator system and/or elevator car. Accordingly, one or more service technicians may gain immediate access to a wide variety of information regarding the elevator system and/or elevator car to perform maintenance or service without a need to file, organize, and obtain large amounts of paper documents.

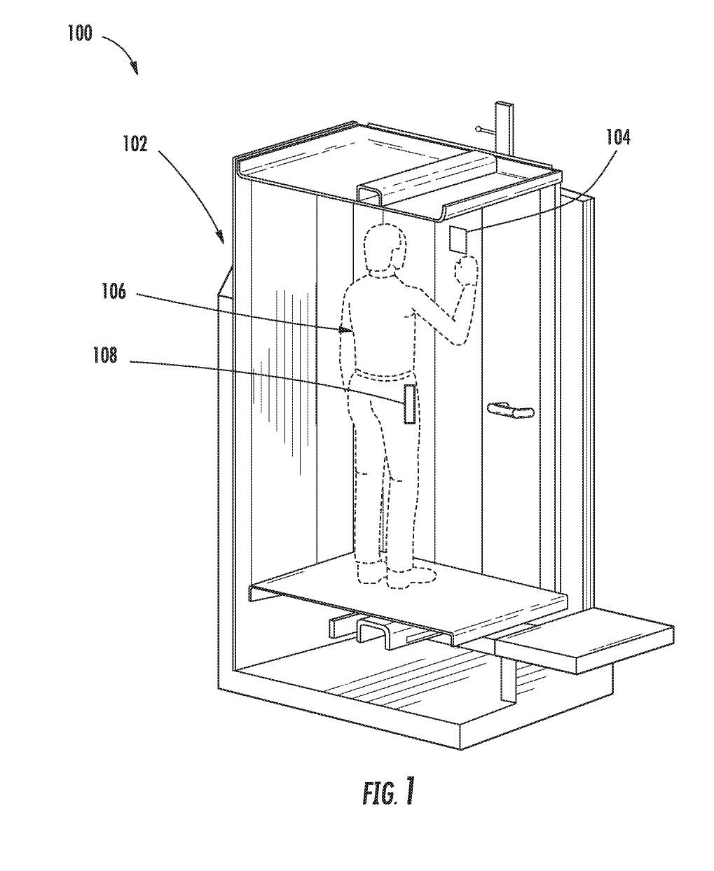

Referring now to FIG. 1, an elevator system 100 including an elevator car 102 is illustrated according to a non-limiting embodiment. The elevator car 102 includes an electronic COP module 104. The COP module 104 includes a graphical user interface that is accessible by a service technician 106. According to an embodiment, the COP module 104 can be configured to operate in a normal mode and a service/maintenance mode. When operating in the normal mode, the COP module 104 performs traditional operations that allow one or more a passengers to input an elevator car request or indicate one or more desired floors at which to deliver the elevator car 102. The COP module 104, however, can also be switched into a service/maintenance mode by a service technician 106. When operating in the service/maintenance mode, the COP module 104 is configured to display various types of service/maintenance to a service technician 106. The various types of service/maintenance may include, but are not limited to, electrical and/or mechanical schematics, blueprints of the elevator system and/or car, part lists, maintenance and/or service history, and step-by-step instructions for diagnosing and/or repairing the elevator system and/or elevator car. In this manner, a service technician 106 can conveniently access various types of information regarding the elevator car and/or elevator system to be worked on without requiring the service technician 106 to file, organize, or handle large amounts of paper documents as discussed in greater detail below.

According to an embodiment, the COP module 104 may further electrically communicate with one or more mobile devices 108. The mobile device 108 may include, but is not limited to, a smart phone, a computer tablet, a computer laptop, or an electronic mobile diagnostic tool possessed by the service technician 106. In this manner, various types of data can be automatically transmitted from the COP module 104 and stored onto the mobile device 108. This allows the service technician 106 to conveniently obtain the service/maintenance information and electronically generate a service report at a later point in time following the performed work.

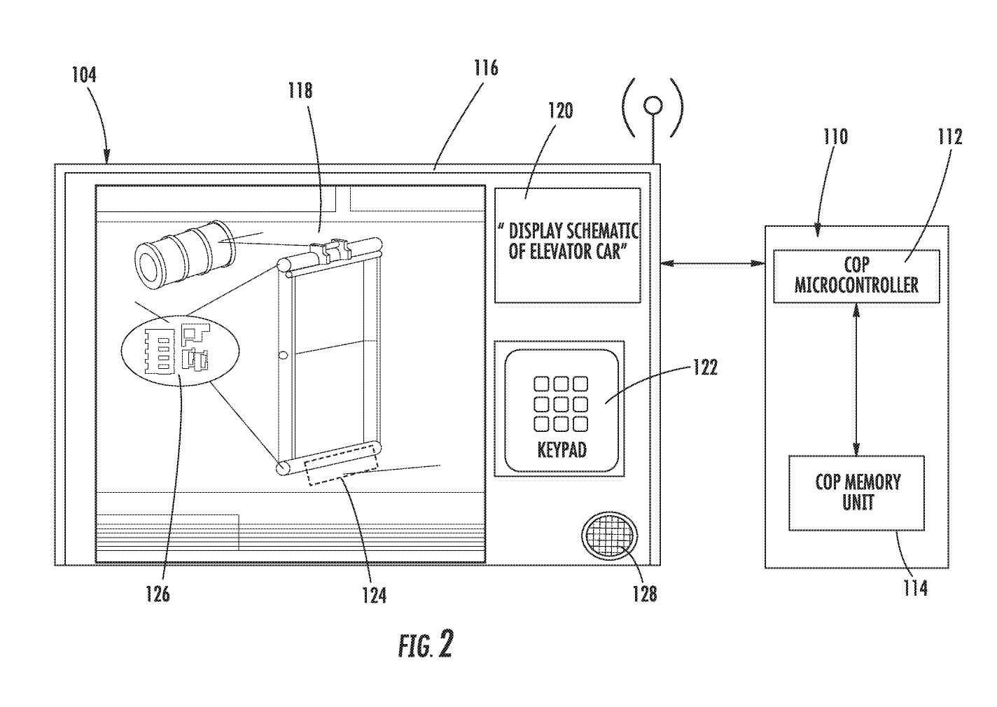

Turning now to FIG. 2, a COP module 104 is illustrated according to a non-limiting embodiment. As mentioned above, in addition to performing traditional elevator car requests and/or desired floor requests, the COP module 104 is configured to perform maintenance, service, and/or diagnostic operations that assist a service technician 106 to facilitate service, maintenance, and/or diagnostics of the elevator system 100 and/or elevator car 102. The COP module 104 is in signal communication with an electronic COP controller unit 110. The COP controller unit 110 includes a microprocessor 112 in signal communication with a COP memory unit 114. As described above, the COP module 104 may also be configured to wirelessly communicate with one or more mobile devices 108 such as, for example, a smart phone, a tablet computer, a laptop computer, and/or an electronic mobile diagnostic tool. In this manner, service/maintenance information provided by the COP module 104 can also be conveniently transmitted to the mobile device 108.

The COP memory unit 114 stores various types of service/maintenance information including, but not limited to, electrical and/or mechanical schematics, blueprints of the elevator system and/or car, part lists, video files, maintenance and/or service history, and step-by-step instructions for diagnosing and/or repairing the elevator system and/or elevator car. The COP memory unit 114 also stores one or more instructions that, when executed by the microprocessor 112, displays various types of service/maintenance to a service technician 106. The COP module 104 comprises a display screen 116 configured to display service/maintenance information 118, a query field 120, and a keypad 122. The display screen 116 may be configured as a touch screen display allowing the service technician 106 to conveniently select and/or input data to the COP module 104. The keypad may include a physical keypad 122 installed on a panel of the elevator car 102 and/or a digital keypad generated by the COP module 104 and displayed on the display screen 116.

According to a non-limiting embodiment, a service technician 106 may manipulate the keypad 122 to input one or more queries into the query field 120. The queries may include, for example, a request for a most recent service/maintenance history of the elevator system and/or the particular car containing the service technician, schematics of the elevator system and/or the elevator car, etc. In response to the input query, the display screen 116 displays one or more types of service/maintenance information 118 such as, for example, a blueprint or schematic 118 of the elevator car 102.

According to another embodiment, the service technician 106 can request a diagnostic analysis of the elevator system 100 and/or elevator car 102. In response to the diagnostic request, the COP controller unit 110 can electrically communicate with a main elevator microcontroller (not shown) to determine one or more diagnostic errors currently existing in the system. In response to the data provided by the main elevator controller, the COP controller unit 110 can display an image of the faulty system or a component contained within the system and overlay a diagnostic indicator indicating the location of the existing diagnostic fault. In addition to visually identifying one or more diagnostic faults, the COP controller unit 110 can search the COP memory unit 114 for one or more replacement parts for fixing the diagnostic fault, and can display the replacement part 126 on the display screen 116. The replacement part 126 can be automatically retrieved by the COP controller unit 110 after completing a diagnosis operation and/or can be retrieved from the memory unit 114 in response to a query input by a service technician 106. In addition to an image of the replacement part 126, the COP controller unit 110 can also display ordering information for the replacement part 126, the price of the replacement part 126, and can ask the service technician 106 whether replacement part 126 should be ordered from a part supplier. If the service technician 106 agrees to purchase the replacement part 126, the COP controller unit 110 can automatically initiate a wireless communication session with a server of the part supplier, and place an order for the replacement part 126 accordingly.

According to another embodiment, the COP memory unit 114 may store step-by-step instructions as to how a diagnosis fault can be resolved. In this manner, a service technician 106 can input a query requesting one or more step-by-step instructions for resolving the diagnostic fault. In response to the query, the COP controller unit 110 cross-references the existing diagnosis fault with one or more instructions stored in the COP memory unit 114 and retrieves the relevant instructions. The retrieved instructions are then displayed on the display screen 116 so that the service technician 106 can remove or repair the existing diagnosis fault. The repair instructions can include, but are not limited to, textual instructions and/or a video stream showing how the diagnostic default can be repaired. Although instructions for resolving the diagnostic fault are described, it should be appreciated that other types of instructions can be displayed including, but not limited to, maintenance information such as, for example, a checklist of the parts to inspect with the frequency of inspection.

In addition to the keypad 112, the COP module 104 may further include an audio system 128. The audio system 128 may include, for example, a speaker and/or microphone. In this manner, a service technician 106 may provide a voice command to the COP module 104 requesting various service/maintenance information. For example, a service technician 106 may submit a voice command stating “What is the diagnosis of the elevator car′?” In response, the COP controller unit 110 can communicate with the main elevator controller to perform a diagnostic operation as discussed above and in response to the diagnostic operation can display a location of a diagnostic fault on the display screen 116. In another example, the service technician 106 can submit a voice command stating “How is the diagnostic fault repaired′?” In response to the voice request, the COP controller unit 110 receives step-by-step instructions for repairing the diagnostic fault from the COP memory unit 114, and displays the step-by-step instructions on the display screen 116 as discussed in detail above. In addition to receiving voice commands from a service technician 106, the COP module 104 may utilize the speaker 128 to recite the step-by-step instructions back to the service technician 106. In addition, the COP module 104 can provide audio of the service/maintenance information displayed on the display screen 116. For example, the COP module 104 can provide an audio output of the name of the replacement part 126 and/or any other related information such as serial numbers, etc.

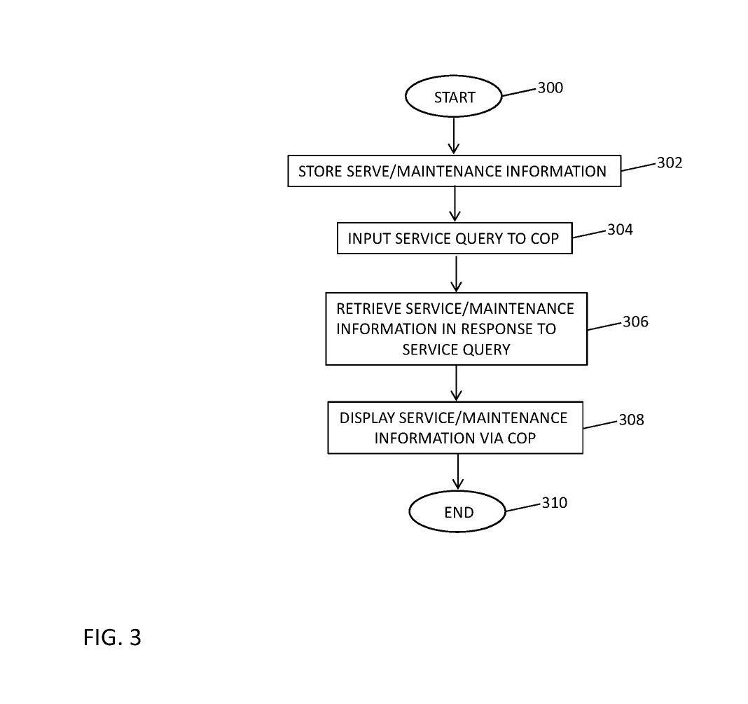

Referring now to FIG. 3, a flow diagram illustrates a method of performing service/maintenance on an elevator system according to a non-limiting embodiment. The method begins at operation 300, and at operation 302 service/maintenance information is stored in an electronic memory device such as random access memory (RAM), for example. At operation 304, a service query is input to a COP by a service technician. The service query may include, but is not limited to, a request for electrical/mechanical schematics, a request for a technical data sheet for one or more components included in the elevator system or elevator car, and a request to execute a diagnostic operation that diagnoses the operation of the elevator system or elevator car. At operation 306, an electronic controller unit including a microprocessor retrieves the service/maintenance information from the memory unit in response to the service query. At operation 308, the COP displays the retrieved service/maintenance information on a display screen, and the method ends at operation 310.

As described in detail above, various embodiments provide an elevator system including an elevator car having a car operating panel (COP) graphical user interface configured to perform maintenance, service, and/or diagnostic operations. Unlike conventional car operating panels, at least one embodiment of the present inventive teachings provides an elevator car including a COP graphical user interface configured to display service/maintenance information to an elevator service technician from within the elevator car. The service/maintenance information may include, but is not limited to, electrical and/or mechanical schematics, blueprints of the elevator system and/or car, part lists, maintenance and/or service history, and step-by-step instructions for diagnosing and/or repairing the elevator system and/or elevator car. Accordingly, one or more service technicians may gain immediate access to a wide variety of information regarding the elevator system and/or elevator car to perform maintenance or service without a need to file, organize, and obtain large amounts of paper documents.

According to the descriptions above, the term “module, controller or unit”, as recited herein, refers to logic embodied in hardware or firmware, or to a collection of computer readable software instructions, written in a programming language including, but not limited to, Java, C, or assembly, and which is executed by one or more electronic microprocessors. One or more software instructions in the modules may be embedded in firmware, such as, for example, in an EPROM, and/or stored in any type of non-transitory computer-readable medium or other storage device.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An elevator car driven by an elevator system, comprising:
an electronic car operation panel (COP) module including a display screen and an input sensor configured to detect a service query;
an electronic memory unit that stores service/maintenance information; and
an electronic COP controller unit including a microprocessor configured to execute computer-readable instructions stored in the electronic memory unit to retrieve the service/maintenance information in response to the service query and output an electronic display signal indicative of the service/maintenance information,
wherein the COP module is configured to display the service/maintenance information in response to receiving the electronic display signal.

2. The elevator car of claim 1, wherein the COP module is installed inside the elevator car.

3. The elevator car of claim 2, wherein the electronic COP controller unit is configured to determine at least one diagnostic fault of at least one of the elevator car and the elevator system, and output a diagnostic signal indicative of the at least one diagnostic fault.

4. The elevator car of claim 3, wherein the COP module is configured to display an image corresponding to the at least one diagnostic fault.

5. The elevator car of claim 4, wherein the COP module is configured to overlay at least one diagnostic indicator on the image identifying a location of the diagnostic fault.

6. The elevator car of claim 2, wherein the COP module includes an audio system configured to receive a vocal request.

7. The elevator car of claim 6, wherein the electronic COP controller unit is configured to retrieve the service/maintenance information in response to the vocal request and output the electronic display signal indicative of the service/maintenance information.

8. The elevator car of claim 7, wherein the audio system is configured to output vocal information corresponding to the retrieved service/maintenance information.

9. The elevator car of claim 2, wherein the COP module is configured to wireless transmit the service/maintenance information to at least one electronic mobile device.

10. The elevator car of claim 1, wherein the service/maintenance information includes at least one of electrical schematics, mechanical schematics, elevator system blueprints, part lists and images, video files, maintenance/service history and checklist, and step-by-step instructions for diagnosing and repairing a diagnosis fault and step-by-step instructions for maintenance.

11. The elevator car of claim 10, wherein the display screen is configured to display a request to order at least one replacement part, and automatically order the at least one replacement part in response to receiving a confirmation via the COP module to order the at least one replacement part.

12. A method of performing service/maintenance on an elevator system, the method comprising:
storing service/maintenance information corresponding to at least one of the elevator system and an elevator car included in the elevator system;
inputting a service query to an electronic car operation panel (COP) module installed on the elevator car;
retrieving the service/maintenance information in response to the service query; and
displaying the service/maintenance information on a display screen of the COP module in response to retrieving the service/maintenance information.

13. The method of claim 12, wherein the COP module is installed inside the elevator car.

14. The method of claim 13, further comprising:
receiving a request to diagnose at least one of the elevator system and the elevator car via the COP module;
determining an existence of at least one diagnostic fault in response to the diagnosis; and
displaying an image via the COP module that identifies a location of the at least one diagnostic fault.

15. The method of claim 12, wherein the service/maintenance information includes at least one of electrical schematics, mechanical schematics, elevator system blueprints, part lists and images, video files, maintenance/service history, and step-by-step instructions for diagnosing and repairing a diagnosis fault.
